(19) United States
(12) Patent Application Publication
(10) Pub. No.: US 2020/0286003 A1
(43) Pub. Date: Sep. 10, 2020

(54) VEHICLE ALLOCATION FOR RIDE REQUESTS

(71) Applicant: ANI TECHNOLOGIES PRIVATE LIMITED, Bengaluru (IN)

(72) Inventors: Sathya Narayanan Nagarajan, Bengaluru (IN); Gaurav Agarwal, Fremont, CA (US)

(73) Assignee: ANI TECHNOLOGIES PRIVATE LIMITED, Bengaluru (IN)

(21) Appl. No.: 16/294,609

(22) Filed: Mar. 6, 2019

(51) Int. Cl. G06Q 10/02; G06Q 50/30; G06Q 10/04; G01C 21/34

(52) U.S. Cl. CPC G06Q 10/02; G01C 21/3438; G06Q 10/047; G06Q 50/30

(57) ABSTRACT

Vehicle allocation for a ride request includes receiving a ride request including a pick-up location. A set of parameters associated with a plurality of vehicles, including at least one autonomous vehicle (AV) and at least one manually-driven vehicle (MV), that are detected within a threshold distance of the pick-up location are analyzed. The set of parameters includes a dry run parameter, a dead run parameter, or a safety score. One of the AV and the MV is selected and allocated to the ride request. The AV is selected when a value of the dry run parameter associated with the AV is less than a value of the dry run parameter associated with the MV. The MV is selected when the value of the dry run parameter associated with the MV is less than the value of the dry run parameter associated with the AV.

### FIELD OF THE DISCLOSURE

Various embodiments of the disclosure relate generally to vehicle allocation systems. More specifically, various embodiments of the disclosure relate to vehicle allocation for ride requests.

### BACKGROUND

Recent developments in the field of transportation services have led to evolution of various online platforms that cater to travelling requirements of passengers. Specifically, transportation platforms that offer on-demand vehicle services to the passengers have emerged as a popular solution to overcome the ever-increasing demand for the transportation services. Usually, a passenger initiates a ride request to travel from a pick-up location to a drop-off location. Transportation service systems process the ride request and allocate a suitable manually-driven vehicle (MV) to cater to the ride request.

In one scenario, it may be possible that a driver of the allocated MV has already driven for a very long duration and is currently exhausted. This may adversely affect the driving capability of the driver and the travel experience of the passenger. In another scenario, it may be possible that the weather and road conditions are not favorable for the driver to drive the MV. Likewise, there are various other factors, such as driver's state-of-mind, driver's health, or driver's familiarity with a particular route, which may affect the driving capability of the driver.

In order to tackle the abovementioned challenges, transport providers make use of autonomous vehicles (AVs) to cater to the ride requests. These AVs, at times, prove to be more efficient than MVs. However, not all ride requests can be allocated to the AVs. For example, there may be a terrain along a route of a particular ride that is not fit to be traversed by an AV, whereas a driver may easily drive an MV on such terrain. Thus, it is highly important to intelligently select the right vehicles to cater to the ride requests. However, in the current implementation, selecting an optimal vehicle (an MV or an AV) for a ride request is a challenging task for the transportation service systems and has immense room for improvement.

In light of the foregoing, there exists a need for a technical and more reliable solution that solves the above-mentioned problems and improves the current implementation of vehicle allocation.

Further areas of applicability of the disclosure will become apparent from the detailed description provided hereinafter. It should be understood that the detailed description of exemplary embodiments is intended for illustration purposes only and is, therefore, not intended to necessarily limit the scope of the disclosure.

### SUMMARY

Vehicle allocation for a ride request is provided substantially as shown in, and described in connection with, at least one of the figures, as set forth more completely in the claims.

These and other features and advantages of the disclosure may be appreciated from a review of the following detailed description of the disclosure, along with the accompanying figures in which like reference numerals refer to like parts throughout.

### BRIEF DESCRIPTION OF THE DRAWINGS

FIG. 1 is a block diagram that illustrates an environment for vehicle allocation, in accordance with an embodiment of the disclosure;

FIG. 2 is a block diagram that illustrates an application server in the environment of FIG. 1, in accordance with an embodiment of the disclosure;

FIG. 3 is a block diagram that illustrates a booking interface rendered on a display of a passenger device in the environment of FIG. 1, in accordance with an exemplary embodiment of the disclosure;

FIG. 4 is a block diagram that illustrates a booking interface rendered on the display of the passenger device of FIG. 1, in accordance with an exemplary embodiment of the disclosure;

FIG. 5 is block diagram that illustrates an exemplary scenario for vehicle allocation, in accordance with an exemplary embodiment of the disclosure;

FIG. 6 is a block diagram that illustrates a notification interface rendered on a display of a driver device in the environment of FIG. 1, in accordance with an exemplary embodiment of the disclosure;

FIG. 7 is a block diagram that illustrates a notification interface rendered on the display of the passenger device of FIG. 1, in accordance with an exemplary embodiment of the disclosure;

FIGS. 8A-8D, collectively, represent a flow chart that illustrates a method for vehicle allocation, in accordance with an embodiment of the disclosure; and

FIG. 9 is a block diagram that illustrates a computer system for vehicle allocation, in accordance with an embodiment of the disclosure.

### DETAILED DESCRIPTION

Certain embodiments of the disclosure may be found in a disclosed apparatus for vehicle allocation to ride requests. Exemplary aspects of the disclosure provide methods and systems for vehicle allocation to ride requests. The method includes one or more operations executed by a server of the system to allocate vehicles to ride requests of passengers. A ride request, including at least a pick-up location, may be received by the server from a passenger device of a passenger. Based on the ride request, a set of parameters associated with a plurality of vehicles may be analyzed by the server. The plurality of vehicles may be detected within a threshold distance of the pick-up location. The plurality of vehicles include at least one autonomous vehicle (AV) and at least one manually-driven vehicle (MV). The set of parameters includes a dry run parameter associated with the plurality of vehicles. One of the AV or the MV is selected from the plurality of vehicles by server based on the analysis of the set of parameters.

In accordance with an embodiment, the AV is selected when a value of the dry run parameter associated with the AV is less than a value of the dry run parameter associated with the MV. The selected AV is allocated to the ride request by the server. Allocation information is communicated to the allocated AV by the server, enabling the allocated AV to reach the pick-up location from a current location of the AV. In accordance with another embodiment, the MV is selected when a value of the dry run parameter associated with the MV is less than a value of the dry run parameter associated with the AV. The selected MV is allocated to the ride request by the server. Allocation information is communicated to a driver of the allocated MV by the server, enabling the driver to reach the pick-up location from a current location of the MV.

In one embodiment, the set of parameters further includes an availability parameter, a dead run parameter, or a safety score associated with the plurality of vehicles. In one example, the AV is selected when the availability parameter associated with the AV indicates that the AV is available and the availability parameter associated with the MV indicates that the MV is unavailable. In another example, the AV is selected when a value of the dead run parameter associated with the AV is greater than a value of the dead run parameter associated with the MV. In another example, the AV is selected when a value of the safety score associated with the AV is greater than a value of the safety score associated with the MV. In another example, the MV is selected when the availability parameter associated with the MV indicates that the MV is available and the availability parameter associated with the AV indicates that the AV is unavailable. In another example, the MV is selected when a value of the dead run parameter associated with the MV is greater than a value of the dead run parameter associated with the AV. In another example, the MV is selected when a value of the safety score associated with the MV is greater than a value of the safety score associated with the AV.

In another embodiment, the set of parameters further includes a driving-duration parameter, an earning parameter, or a driver-state parameter associated with a driver of the MV, and a preference parameter that indicates a vehicle preference of the passenger. In one example, the AV is selected when the driving-duration parameter associated with the driver is greater than a first threshold. In another example, the AV is selected when the earning parameter associated with the driver is greater than or equal to a second threshold. In another example, the AV is selected when the driver state parameter indicates that a current driving pattern of the driver is deviating from a standard driving pattern. In another example, the AV is selected when the preference parameter indicates that the passenger prefers the AV for the ride request. In another example, the MV is selected when the driving-duration parameter associated with the driver is less than the first threshold. In another example, the MV is selected when the earning parameter associated with the driver is less the second threshold. In another example, the MV is selected when the driver state parameter indicates that the current driving pattern of the driver is deviating from the standard driving pattern. In another example, the MV is selected when the preference parameter indicates that the passenger prefers the MV for the ride request.

Thus, the method and system of the disclosure help the AVs to ply on roads in tandem with MVs. The method and system provide an optimal solution for vehicle allocation as the AVs and MVs are allocated to ride requests by taking into consideration parameters associated with drivers (e.g., earning parameter, driving-duration parameter, driver's state, or the like), vehicles (e.g., the AVs and MVs), and passengers. The allocation of the AVs and MVs to the passengers for their respective rides is efficiently and effectively executed by a ride-hailing server and ensures that the drivers of the MVs are neither overburdened nor underutilized, while increasing the overall engagement of the vehicles with the passengers and the overall profitability of transport providers and improving the travelling experience of the passengers.

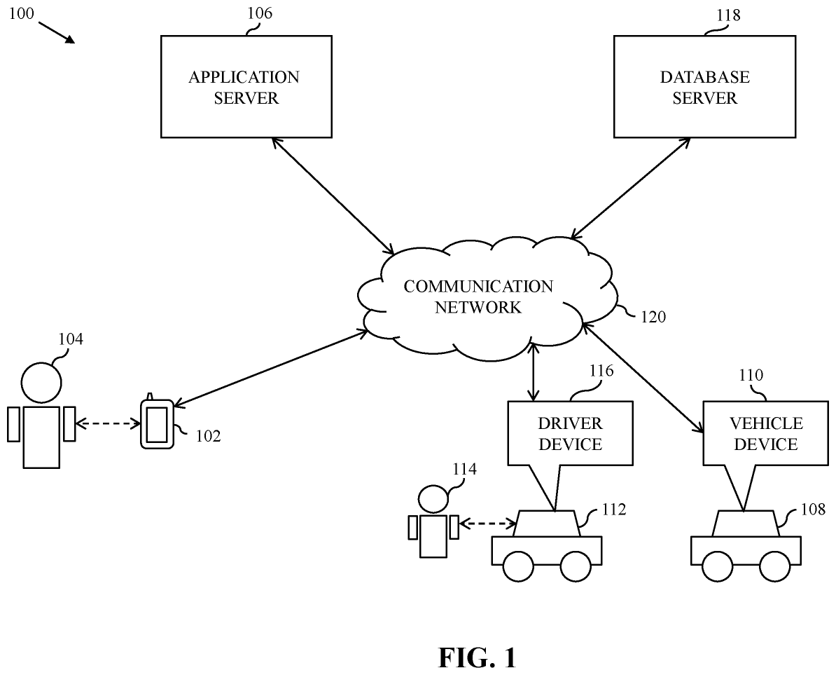

FIG. 1 is a block diagram that illustrates an environment 100 for vehicle allocation, in accordance with an embodiment of the disclosure. The environment 100 includes a passenger device 102, a passenger 104, an application server 106, an autonomous vehicle (AV) 108, a vehicle device 110, a manually-driven vehicle (MV) 112, a driver 114, a driver device 116, and a database server 118. The passenger device 102, the application server 106, the vehicle device 110, the driver device 116, and the database server 118 may communicate with each other by way of a communication network 120.

The passenger device 102 may include suitable logic, circuitry, interfaces, and/or code, executable by the circuitry, that may be configured to perform one or more operations for initiating ride requests. The passenger device 102 may be utilized by the passenger 104 to initiate a ride request for booking a vehicle to travel from a pick-up location to a drop-off location. The passenger device 102 may be configured to run a software application, hosted by the application server 106, that allows the passenger 104 to initiate the ride request. The passenger device 102 may be configured to display various booking and notification interfaces that are rendered by the application server 106 by way of the software application. For example, the passenger device 102 may be configured to display a booking interface that allows the passenger 104 to provide ride information and consents that are required for initiating the ride request. The passenger device 102 may be further configured to communicate the ride request to the application server 106 over the communication network 120. The passenger device 102 may be utilized, by the passenger 104, to view allocation information received from the application server 106. The allocation information notifies the passenger 104 of a vehicle that is allocated to the ride request. Examples of the passenger device 102 may include, but are not limited to, a personal computer, a laptop, a smartphone, a phablet, and a tablet computer.

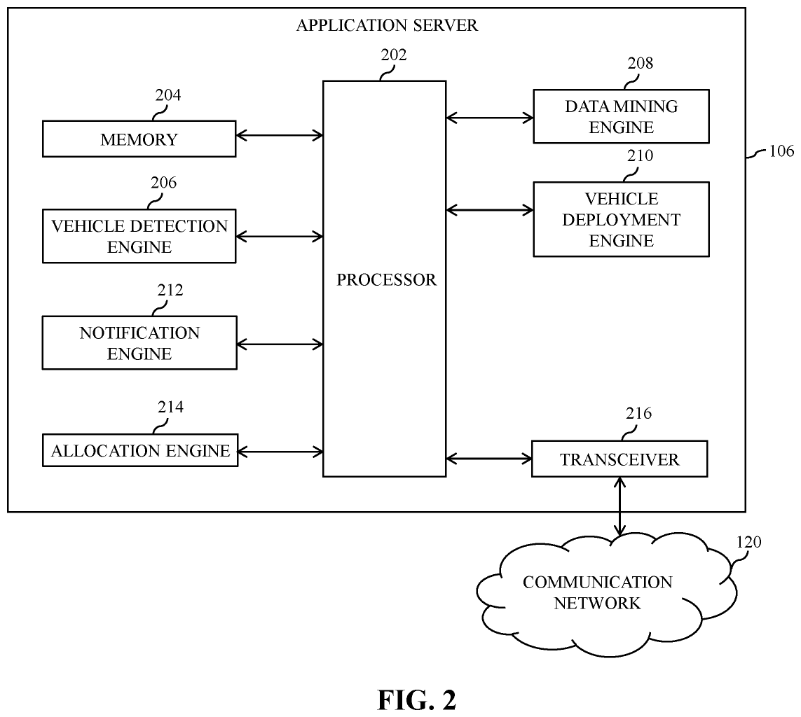

The application server 106 may include suitable logic, circuitry, interfaces, and/or code, executable by the circuitry, that may be configured to perform one or more operations (e.g., execution of programs, routines, scripts, or the like stored in a memory) for vehicle allocation. The application server 106 may be configured to host the software application (for example, a mobile application or a web application) that may run on the passenger device 102. The application server 106 may be configured to receive the ride request from the passenger device 102 over the communication network 120. Based on the ride request, the application server 106 may be configured to select and allocate a suitable vehicle (for example, the AV 108 or the MV 112) to the ride request. The application server 106 may be further configured to communicate the allocation information to the passenger device 102 for notifying the passenger 104 of the allocation of the vehicle. The application server 106 may be realized through various web-based technologies, such as, but not limited to, a Java web-framework, a .NET framework, a PHP (Hypertext Preprocessor) framework, or any other web-application framework. Examples of the application server 106 may include, but are not limited to, a personal computer, a laptop, or a network of computer systems. The application server 106 has been described in detail in conjunction with FIG. 2.

The AV 108 is a vehicle that may include suitable logic, circuitry, interfaces and/or code, executable by the circuitry, that may be configured to control one or more operations of the AV 108. The AV 108 is a driverless vehicle deployed by a transport provider to cater to travelling requirements of various passengers (e.g., the passenger 104). Examples of the AV 108 includes a car, a bus, or the like. The AV 108 may be an electric vehicle, a non-electric vehicle, a semi-electric vehicle, or the like.

The vehicle device 110 may include suitable logic, circuitry, interfaces and/or code, executable by the circuitry, that may be configured to run the software application hosted by the application server 106 and control one or more operations of the AV 108. In one embodiment, when the application server 106 allocates the AV 108 to the ride request of the passenger 104, the vehicle device 110 may be configured to receive the allocation information from the application server 106. Based on the received allocation information, the vehicle device 110 may be configured to control the AV 108 to reach the pick-up location for picking up the passenger 104 and the drop-off location for dropping the passenger 104. The vehicle device 110 may be further configured to track a real-time location of the AV 108 and communicate information of the tracked real time location to the application server 106. The vehicle device 110 may be further configured to process sensor data of one or more sensors (not shown) on the AV 108 for controlling various aspects of vehicle motion (such as propulsion, breaking, acceleration, steering, or the like) and auxiliary behavior (such as controlling lights, controlling temperature in the AV 108, or the like) of the AV 108. Examples of the one or more sensors may include, but are not limited to, accelerometer, odometer, traffic sensor, global positioning sensor (GPS), temperature sensor, computer vision, or the like.

The MV 112 is a vehicle that may include suitable logic, circuitry, interfaces and/or code, executable by the circuitry, that may be configured to control one or more operations of the MV 112. The MV 112 is a vehicle that is driven by the driver 114. The MV 112 is deployed by the transport provider to cater to travelling requirements of various passengers (e.g., the passenger 104). Examples of the MV 112 includes a car, a bus, or the like. The MV 112 may be an electric vehicle, a non-electric vehicle, a semi-electric vehicle, or the like.

The driver device 116 may include suitable logic, circuitry, interfaces and/or code, executable by the circuitry, that may be configured to run the software application hosted by the application server 106. In one embodiment, when the application server 106 allocates the MV 112 to the ride request of the passenger 104, the driver device 116 may be configured to receive the allocation information from the application server 106. Based on the allocation information, the driver device 116 may be configured to display a navigation interface to guide the driver 114 to reach the pick-up location for picking up the passenger 104 in the MV 112. The navigation interface may be further configured to present a route between the pick-up location and the drop-off location to guide the driver 114 to reach the drop-off location from the pick-up location for dropping the passenger 104. The driver device 116 may be further configured to track a real-time location of the MV 112 and communicate information of the tracked real-time location to the application server 106. The driver device 116 may be further configured to communicate sensor data of one or more sensors (not shown) on the MV 112 to the application server 106. Examples of the one or more sensors may include, but are not limited to, accelerometer, odometer, traffic sensor, global positioning sensor (GPS), temperature sensor, cameras, or the like.

In one embodiment, the vehicle device 110 and the driver device 116 may be vehicle head units. In another embodiment, the vehicle device 110 and the driver device 116 may be external communication devices, such as a smartphone, a tablet, a computer, a laptop, a phablet, or any other portable communication device, that are placed inside the AV 108 or the MV 112, respectively.

The database server 118 may include suitable logic, circuitry, interfaces and/or code, executable by the circuitry, that may be configured to perform one or more data management and storage operations. For example, the database server 118 may be configured to manage and store historical travel data of passengers (e.g., the passenger 104), who have travelled in one or more vehicles deployed by the transport provider, and historical driving data of drivers (e.g., the driver 114), who drive various MVs (e.g., the MV 112) deployed by the transport provider. The historical travel data of the passenger 104 may be indicative of the details of rides taken by the passenger 104 on the vehicles (e.g., the AV 108 and the MV 112) deployed the transport provider, in the past. The details of the rides taken by the passenger 104 may include historical pick-up and drop-off locations, a frequency of rides between the historical pick-up and drop-off locations, preferences of the passenger 104 for one or more vehicle types (e.g., autonomous, manual, or self-driven), or the like. The historical driving data of the driver 114 may be indicative of the details of rides that were allocated to the driver 114 by the application server 106, in the past. The details of the rides allocated to the driver 114 may include historical pick-up and drop-off locations, duration of each ride, working hours of the driver 114, or any other travel data. The historical travel data and the historical driving data may be stored in the database server 118 by the application server 106.

The database server 118 may be further configured to manage and store passenger information of the passengers (e.g., the passenger 104), driver information of the drivers (e.g., the driver 114), and vehicle information of the vehicles (e.g., the AV 108 and the MV 112) that are deployed by the transport provider. The passenger information of the passenger 104 may include at least a name, a contact number, an e-mail address, or other related information of the passenger 104. The driver information of the driver 114 may include a name, a contact number, an e-mail address, an identity proof, a nominal driving pattern, and/or other related information of the driver 114. In a scenario where the driver 114 owns the MV 112 deployed by the transport provider, the driver information of the driver 114 may further include a vehicle number of the MV 112. The vehicle information of the AV 108 and the MV 112 may include registered numbers, colors, models, and/or other related information of the AV 108 and the MV 112.

The database server 118 may be configured to receive a query from the application server 106 over the communication network 120 for retrieval of the stored information. Based on the received query, the database server 118 may be configured to communicate the requested information to the application server 106 over the communication network 120. Examples of the database server 118 may include, but are not limited to, a personal computer, a laptop, or a network of computer systems.

The communication network 120 may include suitable logic, circuitry, interfaces, and/or code, executable by the circuitry, that may be configured to transmit messages and requests between various entities, such as the passenger device 102, the application server 106, the vehicle device 110, the driver device 116, and/or the database server 118. Examples of the communication network 120 include, but are not limited to, a Wi-Fi network, a light fidelity (Li-Fi) network, a local area network (LAN), a wide area network (WAN), a metropolitan area network (MAN), a satellite network, the Internet, a fiber optic network, a coaxial cable network, an infrared (IR) network, a radio frequency (RF) network, and combinations thereof. Various entities in the environment 100 may connect to the communication network 120 in accordance with various wired and wireless communication protocols, such as Transmission Control Protocol and Internet Protocol (TCP/IP), User Datagram Protocol (UDP), Long Term Evolution (LTE) communication protocols, or any combination thereof.

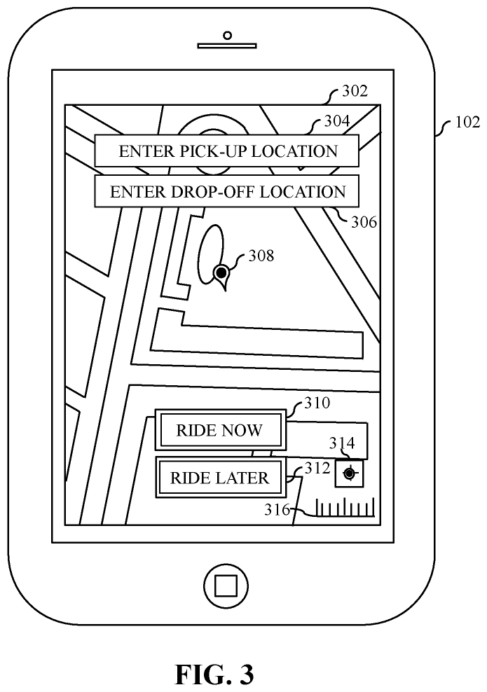

In operation, the application server 106 may be configured to host the software application (e.g., a mobile application or a web application) to cater to travelling requirements of the passengers (e.g., the passenger 104). The software application may be used by the passengers to initiate ride requests for booking vehicles for travelling between locations. The passenger device 102 may be configured to run the software application hosted by the application server 106. The software application may be accessed by the passenger 104 when the passenger 104 wants to initiate a ride request for traveling from a first location ‘A’ (i.e., the pick-up location) to a second location ‘B’ (i.e., the drop-off location). When the software application is accessed by the passenger 104, the passenger device 102 may be configured to render a booking interface thereon. The booking interface may be utilized by the passenger 104 to provide an address of the first location ‘A’. In one example, the passenger 104 may manually input the address of the first location ‘A’. In another example, when the first location ‘A’ is a current location of the passenger 104, the passenger device 102 may track a real-time location of the passenger 104 and enter an address of the real-time location to the booking interface. The booking interface may be further utilized by the passenger 104 to provide other ride-related information, for example, an address of the second location ‘B’, a pick-up time, a drop-off time, a model preference for a vehicle model (e.g., hatchback, sedan, multi-utility, sports utility, or cross-over), or the like. After providing the address of the first location ‘A’, the ride request may be initiated by the passenger 104 by way of the booking interface. An exemplary booking interface is described later in FIG. 3.

The passenger device 102 may be configured to communicate the ride request to the application server 106 over the communication network 120. The ride request includes the address of the pick-up location of the passenger 104. The ride request may further include the address of the drop-off location and other ride related information (e.g., scheduling time of the ride) provided by the passenger 104. The application server 106 may be configured to receive the ride request and cause the passenger device 102 to render another booking interface thereon by way of the software application. The booking interface may enable the passenger 104 to input a type preference for a vehicle type (i.e., autonomous, manual, self-driven, or no preference). The passenger device 102 may be configured to communicate the type preference provided by the passenger 104 to the application server 106 over the communication network 120. The application server 106 may receive the type preference of the passenger 104.

The application server 106 may be configured to detect various vehicles, including AVs and MVs, that are present within a threshold distance from the first location ‘A’. In one embodiment, the threshold distance may be a fixed value defined by the transport provider. In another embodiment, the threshold distance may be a variable value determined by the application server 106 based on real-time demand and supply of vehicles. The detection of the vehicles may be based on the real-time locations of the vehicles. For example, the application server 106 may continuously receive the information of the real-time locations of all AVs and MVs that are deployed by the transport provider and determine which vehicles are currently located within the threshold distance from the first location ‘A’. In a non-limiting example, it is assumed that the AV 108 and the MV 112 are detected to be located within the threshold distance from the first location ‘A’.

The application server 106 may be configured to receive sensor data from the vehicle device 110 and the driver device 116 of the detected vehicles (i.e., the AV 108 and the MV 112). The sensor data may indicate various aspects of vehicle motion and auxiliary behavior of the detected vehicles. The sensor data received from the driver device 116 may further indicate one or more characteristics of a behavior of the driver 114. The application server 106 may be further configured to determine a current supply of the vehicles deployed by the transport provider, real-time climate and road conditions associated with the first and second locations ‘A’ and ‘B’, and official-working hours of the driver 114. In one embodiment, the working hours may be defined by the transport provider. For example, the working hours of a driver may be 8 hours. In another embodiment, the working hours may correspond to an average time duration for which drivers employed by the transport provider drive the MVs to serve various ride requests. Based on the sensor data, the current supply of the vehicles, the real-time climate and road conditions, and the official-working hours of the driver 114, the application server 106 may be configured to determine values of a first set of parameters associated with each of the AV 108 and the MV 112 (i.e., the detected vehicles) and a second set of parameters associated with the driver 114.

The first set of parameters may include an availability parameter, a dead run parameter, a dry run parameter, and/or a safety score. The availability parameter indicates whether a detected vehicle is available for catering to a ride request. For example, when the AV 108 is already allocated to a previous ride request and may not be able to cater to the ride request of the passenger 104, the availability parameter indicates that the AV 108 is not available. In another example, when the AV 108 is not allocated to any previous ride request, the availability parameter indicates that the AV 108 is available. In another embodiment, when the AV 108 is already allocated to a previous ride request and may be able to cater to the ride request of the passenger 104 after dropping off the current passenger, the availability parameter indicates that the AV 108 is available. Likewise, the availability parameter associated with the MV 112 indicates whether the MV 112 is available for catering to the ride request of the passenger 104. The dead run parameter associated with a detected vehicle may indicate a time duration or a distance travelled for which the detected vehicle is not allocated to any ride request. In one example, the AV 108 may be allocated to a ride request at 06:30 PM and may complete the ride at 07:10 PM. The AV 108 may be again allocated to another ride request at 07:30 PM. Thus, the time duration (i.e., 20 minutes) between 07:10 PM and 07:30 PM for which there was no ride request allocated to the AV 108 may represent the dead run parameter for the AV 108. In another example, when the AV 108 completes a previous ride, odometer reading of the AV 108 may be 236 kms and when the AV 108 is again allocated to another ride, the odometer reading of the AV 108 may be 242 kms. Thus, the distance travelled (i.e., 242 kms−236 kms=6 kms) by the AV 108 for which there was no ride request allocated to the AV 108 indicates the dead run parameter for the AV 108 Likewise, the dead run parameter associated with the MV 112 indicates a time duration or a distance travelled for which the MV 112 is not allocated to any ride request. The dry run parameter associated with a detected vehicle may indicate a time duration taken or a distance travelled by a detected vehicle to reach the pick-up location from a current location of the detected vehicle or a drop-off location of a current passenger already travelling in the detected vehicle. In one example, the AV 108 may need 15 minutes to reach the first location ‘A’ from the AV's 108 current location. Thus, the dry run parameter associated with the AV 108 represents 15 minutes. In another example, the AV 108 may take 15 minutes to reach the pick-up location after dropping off a current passenger at a drop-off location. Thus, the dry run parameter associated with the AV 108 represents 15 minutes. In another example, the AV 108 may have to travel 2 kms to reach the pick-up location from the AV's 108 current location. Thus, the dry run parameter associated with the AV 108 represents 2 kms. In another example, the AV 108 may have to travel 2 kms to reach the pick-up location after dropping off a current passenger at a drop-off location. Thus, the dry run parameter associated with the AV 108 represents 2 kms. Likewise, the MV 112 may take 25 minutes or may have to travel 2.5 kms to reach the first location ‘A’ after dropping off a current passenger at a drop-off location. Thus, the dry run parameter associated with the MV 112 represents 25 minutes or 2.5 kms. The safety score associated with a detected vehicle indicates a degree of safeness of the detected vehicle, i.e., how safe is it for the detected vehicle to reach the drop-off location from the pick-up location. For example, if the safety score of the AV 108 is greater than the safety score of the MV 112, the AV 108 is determined to be safer than the MV 112 for catering to the ride request. The safety score may be dependent on the real-time climate and road conditions associated with the pick-up and drop-off locations and vehicle characteristics. The safety score of the MV 112 may be further dependent on a skill level and experience of the driver 114.

The second set of parameters may include a driving-duration parameter, an earning parameter, and/or a driver-state parameter. The driving-duration parameter associated with the driver 114 may be a Boolean variable that indicates whether the driver 114 has driven the MV 112 for the working hours (i.e., a first threshold value). In one example, the driving-duration parameter may be either ‘1’ or ‘0’. In another example, the driving-duration parameter may be either ‘true’ or ‘false’. When a time duration for which the driver 114 has driven the MV 112 is less than the working hours, the driving-duration parameter is ‘0’ and when the time duration exceeds or becomes equal to the working hours, the driving-duration parameter becomes equal to ‘1’. The earning parameter of the driver 114 may represent a value that indicates an amount of money earned by the driver 114 during a stipulated period of time, for example a day, a week, a month, or the like. In an exemplary scenario, when the ride request is initiated by the passenger 104, the driver 114 may have earned $200 since morning. Thus, the earning parameter of the driver 114 may represent $200. The driver-state parameter of the driver 114 may indicate whether the driver 114 is in a condition to drive the MV 112 safely, i.e., without deviating from a standard driving pattern. The standard driving pattern may indicate a desired driving pattern by taking into consideration, but not limited to, a defined range of speed, frequency of breaking, or the like. For example, the driver 114 may be tired and may deviate from the standard driving pattern. In this scenario, the driver-state parameter may be represented as ‘0’ indicating that the driver 114 is not fit for driving. The driver-state parameter may be determined by the application server 106 by comparing the standard driving pattern with a current driving pattern of the driver 114. The current driving pattern of the driver 114 may be determined based on the sensor data (for example, speed, frequency of breaking, images of drivers driving the MV 112, or the like) and the characteristics of the behavior of the driver 114.

The application server 106 may be configured to analyze the values of the first set of parameters associated with each of the AV 108 and the MV 112 and the second set of parameters associated with the driver 114. During the analysis of the first set of parameters, the application server 106 may be configured to compare the values of the first set of parameters associated with the AV 108 with the values of the corresponding first set of parameters associated with the MV 112. For example, the application server 106 may compare a value of the dry run parameter of the AV 108 with a value of the dry run parameter of the MV 112. The application server 106 may further analyze the values of the second set of parameters associated with the driver 114. During the analysis of the second set of parameters, the application server 106 may be configured to compare the values of the second set of parameters of the driver 114 with predefined threshold values. For example, the application server 106 may compare the values of the driving-duration parameter, the earning parameter, and/or the driver-state parameter with first through third threshold values, respectively.

Based on the result of analysis and comparisons, the application server 106 may select one of the AV 108 and the MV 112. In one example, when the availability parameter of the MV 112 indicates that the MV 112 is unavailable and the AV 108 is available, the application server 106 may select the AV 108. In an alternate example, when the availability parameter of the AV 108 indicates that the AV 108 is unavailable and the MV 112 is available, the application server 106 may select the MV 112. In another example, when the safety score of the AV 108 is greater than the safety score of the MV 112, the application server 106 may select the AV 108. In an alternate example, when the safety score of the MV 112 is greater than the safety score of the AV 108, the application server 106 may select the MV 112. In another example, when the dead run parameter of the MV 112 is greater than the dead run parameter of the AV 108, the application server 106 may select the MV 112. In another example, when the dry run parameter of the MV 112 is greater than the dry run parameter of the AV 108, the application server 106 may select the MV 112. Likewise, when the driving-duration parameter of the driver 114 is less than the first threshold value (for example, the official driving duration such as 8 hours), the application server 106 may select the MV 112. In another example, when the earning parameter of the driver 114 is less than the second threshold value (for example, a daily wage, $500), the application server 106 may select the MV 112. In another example, when the driver-state parameter of the driver 114 indicates that the current driving pattern of the driver is deviating from the standard driving pattern, the application server 106 may select the AV 108.

In one embodiment, based on the analysis and comparisons of the values of the first and second parameters, the application server 106 may be configured to assign a rank to each of the AV 108 and the MV 112. The rank may represent a cumulative result of the comparison and indicate fitness and suitability of the corresponding vehicle for the ride request. The application server 106 may be configured to select one of the AV 108 and the MV 112 that has the higher rank. The application server 106 may be configured to allocate the selected vehicle (i.e., one of the AV 108 or the MV 112 having the higher rank) to the ride request. In one embodiment, the application server 106 may be configured to assign the rank further based on the type and model preferences specified by the passenger 104. For example, if the type preference is autonomous, the application server 106 may assign a higher rank to the AV 108 than the MV 112 and allocate the AV 108 to the ride request.

The application server 106 may be configured to communicate the allocation information to the passenger device 102 to inform the passenger 104 of the allocation of the selected vehicle. The allocation information includes an estimated time to complete the ride, an estimated fare to be charged for the ride, an estimated time of arrival at the second location ‘B’, vehicle information of the allocated vehicle, or the like. The allocation information may further include the driver information of the driver 114 when the MV 112 is allocated to the ride request. The passenger device 102 may be configured to render a notification interface to present the allocation information to the passenger 104.

In one embodiment, when the AV 108 is allocated to the ride request, the application server 106 may be configured to communicate the allocation information to the vehicle device 110. The vehicle device 110 may be configured to control the AV 108 to reach the first location ‘A’ to pick-up the passenger 104. Once the AV 108 is boarded by the passenger 104, the ride begins and the AV 108 may be configured to take the passenger 104 to the second location ‘B’ for drop-off. When the AV 108 drops the passenger 104 at the second location ‘B’, the vehicle device 110 communicates a ride completion notification to the application server 106 indicating that the ride is completed.

In an alternate embodiment, when the MV 112 is allocated to the ride request, the application server 106 may be configured to communicate the allocation information to the driver device 116. The driver device 116 may be configured to render thereon another notification interface to present the allocation information to the driver 114. The ride request may be accepted, rejected, or modified by the driver 114 by way of the notification interface. When the ride request is accepted by the driver 114, the driver device 116 may be configured to display a route and navigation directions to reach the first location ‘A’ from a current location of the MV 112. Once the MV 112 is boarded by the passenger 104, the ride begins and the MV 112 is driven by the driver 114 to reach the second location ‘B’ for dropping off the passenger 104. The driver device 116 may be configured to communicate the ride completion notification to the application server 106 indicating that the ride is completed when the passenger 104 is dropped off at the second location ‘B’.

In one embodiment, the allocation information communicated to the passenger device 102 may further include a ride request identifier which is required by the passenger 104 to start the ride when the allocated vehicle reaches the first location ‘A’. In an exemplary scenario, the ride request identifier may be a one-time password (OTP), a quick response (QR) code, or the like.

During the ride, the passenger device 102 may be utilized by the passenger 104 to control one or more functions of the allocated vehicle, such as entertainment devices, AC, lights, or the like. The passenger device 102 may be further utilized by the passenger 104 to add one or more milestones, modify the route of, or cancel the ongoing ride. The passenger 104 may further make use of the passenger device 102 to view the vehicle information of the allocated vehicle and ride information of the ongoing ride.

When the ride is completed, payment for the ride is made by the passenger 104 via a plurality of payment options. The plurality of payment options may include, but are not limited to, cash, debit card, credit card, e-wallet, internet banking, unified payment interface (UPI), or the like. When the payment is made, the application server 106 is notified of the completion of the ride. The availability parameter of the allocated vehicle now indicates that the vehicle is available for taking another ride request.

FIG. 2 is a block diagram that illustrates the application server 106, in accordance with an embodiment of the disclosure. The application server 106 may include a processor 202, a memory 204, a vehicle detection engine 206, a data mining engine 208, a vehicle deployment engine 210, a notification engine 212, an allocation engine 214, and a transceiver 216 that may be configured to communicate with each other by way of a communication bus (not shown).

The processor 202 may include suitable logic, circuitry, interfaces, and/or codes, executable by the circuitry, that may be configured to perform one or more operations for vehicle allocation. For example, the processor 202 may be configured to control and manage detection of the AVs and MVs for the ride request by using the vehicle detection engine 206 and retrieval of requisite information from the database server 118 by using the data mining engine 208. The processor 202 may be further configured to control deployment of the vehicles (e.g., the AV 108 and the MV 112) by using the vehicle deployment engine 210 and rendering of booking and/or notification interfaces on the passenger device 102, the vehicle device 110, or the driver device 116 by using the notification engine 212. The processor 202 may be further configured to control and manage selection and allocation of the AV 108 or the MV 112 to the ride request by using the allocation engine 214.

In one embodiment, the processor 202 may be configured to operate as a master processing unit, and the vehicle detection engine 206, the data mining engine 208, the vehicle deployment engine 210, the notification engine 212, and the allocation engine 214 may be configured to operate as slave processing units. In such a scenario, the processor 202 may be configured to instruct the vehicle detection engine 206, the data mining engine 208, the vehicle deployment engine 210, the notification engine 212, and the allocation engine 214 to perform corresponding operations either independently or in conjunction with each other. Examples of the processor 202 may include, but are not limited to, an application-specific integrated circuit (ASIC) processor, a reduced instruction set computing (RISC) processor, a complex instruction set computing (CISC) processor, and a field-programmable gate array (FPGA). It will be apparent to a person skilled in the art that the processor 202 is compatible with multiple operating systems.

The memory 204 may include suitable logic, circuitry, interfaces, and/or codes, executable by the circuitry, that may be configured to store one or more instructions executable by the processor 202, the vehicle detection engine 206, the data mining engine 208, the vehicle deployment engine 210, the notification engine 212, and the allocation engine 214. The memory 204 may be configured to temporarily store the historical travel data, the historical driving data, the passenger information, the driver information, and/or the vehicle information retrieved from the database server 118. The memory 204 may be further configured to store the ride request initiated by the passenger 104. Examples of the memory 204 may include, but are not limited to, a random-access memory (RAM), a read-only memory (ROM), a programmable ROM (PROM), and an erasable PROM (EPROM).

The vehicle detection engine 206 may include suitable logic, circuitry, interfaces, and/or codes, executable by the circuitry, that may be configured to execute one or more vehicle detection operations. For example, the vehicle detection engine 206 may be configured to detect the AV 108 and the MV 112 that are present within the threshold distance from the pick-up location (e.g., the first location ‘A’) specified in the ride request. The AV 108 and the MV 112 may be detected based on corresponding real-time locations obtained from the vehicle device 110 and the driver device 116, respectively. The vehicle detection engine 206 may be implemented by one or more processors, such as, but are not limited to, an ASIC processor, a RISC processor, a CISC processor, and/or an FPGA.

The data mining engine 208 may include suitable logic, circuitry, interfaces, and/or codes, executable by the circuitry, that may be configured to execute one or more data mining operations. For example, the data mining engine 208 may be configured to retrieve the historical travel data and the historical driving data from the database server 118 based on the ride request and store the historical travel data and the historical driving data in the memory 204. The data mining engine 208 may be further configured to retrieve the passenger information, the driver information, and/or the vehicle information from the database server 118 based on the ride request and store the passenger information, the driver information, and/or the vehicle information in the memory 204. The data mining engine 208 may be configured to obtain the sensor data from the vehicle device 110 and the driver device 116 when the AV 108 and the MV 112 are detected to be presented within the threshold distance of the first location ‘A’ and store the sensor data in the memory 204. The data mining engine 208 may be further configured to obtain a current status of an ongoing ride and store the current status in the memory 204. The data mining engine 208 may be implemented by one or more processors, such as, but not limited to, an ASIC processor, a RISC processor, a CISC processor, and an FPGA.

The notification engine 212 may include suitable logic, circuitry, interfaces, and/or codes, executable by the circuitry, that may be configured to execute one or more operations for rendering the booking and notification interfaces on the passenger device 102 and the driver device 116. For example, the notification engine 212 may be configured to render the first and booking interfaces and the notification interfaces on the passenger device 102 by way of the software application that runs on the passenger device 102. The booking interfaces and notification interfaces may be graphical user interfaces (GUIs) that may allow the passenger 104 to interact with the application server 106 for initiating the ride request. The notification engine 212 may be implemented by one or more processors, such as, but not limited to, an ASIC processor, a RISC processor, a CISC processor, and an FPGA.

The allocation engine 214 may include suitable logic, circuitry, interfaces, and/or codes, executable by the circuitry, that may be configured to perform one or more operations for vehicle selection and allocation. For example, the allocation engine 214 may be configured to select and allocate the AV 108 or the MV 112 to the ride request of the passenger 104 based on the first and second set of parameters and the type and model preference of the passenger 104. The allocation engine 214 may be implemented by one or more processors, such as, but not limited to, an ASIC processor, a RISC processor, a CISC processor, and an FPGA.

The transceiver 216 may include suitable logic, circuitry, interfaces, and/or codes, executable by the circuitry, that may be configured to transmit (or receive) data to (or from) various servers or devices, such as the passenger device 102, the vehicle device 110, the driver device 116, the database server 118, or the like over the communication network 120. Examples of the transceiver 216 may include, but are not limited to, an antenna, a radio frequency transceiver, a wireless transceiver, and a Bluetooth transceiver. The transceiver 216 may be configured to communicate with the passenger device 102, the vehicle device 110, the driver device 116, the database server 118 using various wired and wireless communication protocols, such as TCP/IP, UDP, LTE communication protocols, or any combination thereof.

FIG. 3 is a block diagram that illustrates a booking interface 302 rendered on the display of the passenger device 102, in accordance with an exemplary embodiment of the disclosure. The notification engine 212 may be configured to render the booking interface 302 on the display of the passenger device 102 by way of the software application that runs on the passenger device 102. The booking interface 302 may enable the passenger 104 to initiate the ride request (as described in FIG. 1). The booking interface 302 may present a geographical map and a first set of selectable options to the passenger 104. The first set of selectable options may include a first textbox 304, a second textbox 306, a navigation cursor 308, a ‘ride now’ button 310, a ‘ride later’ button 312, a current-location detection button 314, and a distance scale 316. The first and second textboxes 304 and 306 may be used by the passenger 104 to enter addresses of the pick-up and drop-off locations, respectively, in textual format. The navigation cursor 308 may be moved around the geographical map by way of touch-inputs provided by the passenger 104 on the passenger device 102 and used to pin the pick-up and drop-off locations on the geographical map. The ‘ride now’ button 310 may be selected by the passenger 104 when the passenger 104 wants to initiate the ride request for scheduling a ride immediately. The ‘ride later’ button 312 may be selected by the passenger 104 when the passenger 104 wants to initiate the ride request for scheduling the ride for a particular time in future. The current-location detection button 314, when selected, may move the navigation cursor 308, to a real-time location of the passenger device 102. The distance scale 316, may be used by the passenger 104 to zoom in to or zoom out of the geographical map.

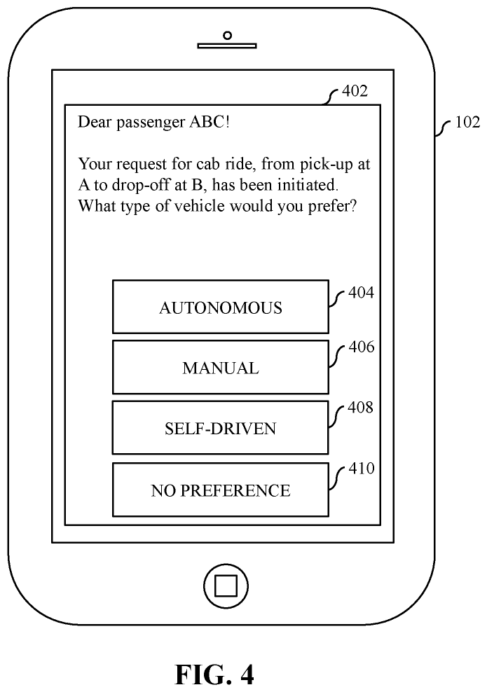

FIG. 4 is a block diagram that illustrates a booking interface 402 rendered on the display of the passenger device 102, in accordance with an exemplary embodiment of the disclosure. The notification engine 212 may be configured to render the booking interface 402 on the display of the passenger device 102 by way of the software application. The booking interface 402 may be rendered when the ride request is received by the application server 106. The booking interface 402 may enable the passenger 104 to provide the type preference for booking a vehicle for the ride and present a second set of selectable options. The second set of selectable options may include first through fourth buttons 404-410. The first button 404 may indicate an autonomous vehicle type and the second button 406 may indicate a manual vehicle type. The third button 408 may indicate a self-driven vehicle type and the fourth button 410 may indicate no preference. The allocation engine 214 may be configured to allocate the AV 108 or the MV 112 to the ride request based on the type preference provided by the passenger 104. For example, the allocation engine 214 may be configured to allocate the AV 108, when the first button 404 is selected by the passenger 104. The allocation engine 214 may be configured to allocate the MV 112, when the second button 406 is selected by the passenger 104. The allocation engine 214 may be configured to allocate a self-driven vehicle (not shown), when the third button 408 is selected by the passenger 104. The allocation engine 214 may allocate any of the AV 108 or the MV 112 based on the rank when the fourth button 410 is selected by the passenger 104 (i.e., indicating that the passenger 104 is comfortable with both autonomous and manual vehicle types).

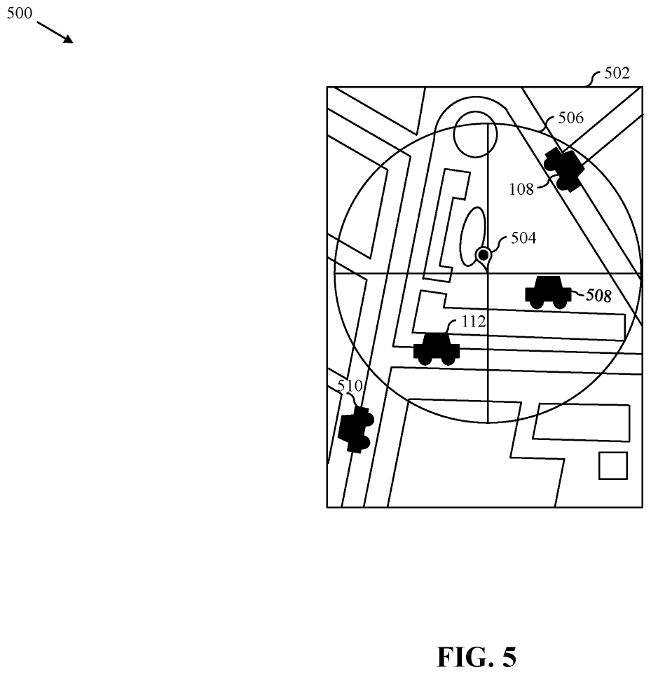

FIG. 5 is a block diagram that illustrates an exemplary scenario 500 for vehicle allocation, in accordance with an exemplary embodiment of the disclosure. The exemplary scenario 500 illustrates a geographical map 502 including a pick-up location 504 of the ride request. When the application server 106 receives the ride request and the type preference from the passenger device 102, the application server 106 may be configured to detect the presence of various AVs and MVs that are within the threshold distance from the pick-up location 504. Region of the geographical map 502 that lies within the threshold distance from the pick-up location 504 is represented by a boundary 506. The application server 106 may detect that the AV 108, the MV 112, and another MV 508 are present within the threshold distance from the pick-up location 504, i.e., inside the boundary 506. However, another MV 510 may not be detected by the application server 106 as the MV 510 is outside the boundary 506.

After the detection of the AV 108 and the MVs 112 and 508, the application server 106 may be configured to determine values of the first set of parameters associated with each of the AV 108 and the MVs 112 and 508, and the second set of parameters associated with the driver 114 of the MV 112 and a second driver (not shown) of the MV 508. The application server 106 may be configured to analyze the values of the first set of parameters associated with each of the AV 108 and the MVs 112 and 508 and the second set parameters associated with the driver 114 and the second driver, and select one of the AV 108 and the MVs 112 and 508 by using the allocation engine 214. In one exemplary scenario, the availability parameter of the MV 508 may indicate that the MV 508 is not available, thus, the MV 508 is not selected. In another exemplary scenario, the type preference specified by the passenger 104 may be autonomous. Thus, the application server 106 may be configured to select the AV 108 for the ride request. For the sake of simplicity, it is assumed that the availability parameter of the MV 508 indicates that the MV 508 is not available and the availability parameters of the AV 108 and the MV 112 indicate that the AV 108 and the MV 112 are available and the passenger 104 has not provided any type preference. In this scenario, the application server 106 may be configured to assign ranks to the AV 108 and the MV 112 based on the analysis of the first and second sets of parameters and select one of the AV 108 and the MV 112 that has the higher rank.

In one example, the AV 108 may have the higher rank when the driving-duration parameter and the earning parameter of the driver 114 exceed the first and second threshold values, respectively. In another example, the MV 112 may be assigned the higher rank when the value of the dead run parameter associated with the MV 112 is greater than the value of the dead run parameter associated with the AV 108. In another example, the MV 112 may be assigned the higher rank when the value of the dry run parameter associated with the AV 108 is greater than the value of the dry run parameter associated with the MV 112. In another example, the AV 108 may be assigned the higher rank when the safety score associated with the AV 108 is greater than the safety score associated with the MV 112. In another example, the driver-state parameter of the driver 114 may indicate that the current driving behavior of the driver 114 is deviating from the standard driving behavior. In this example, the AV 108 may be assigned the higher rank than the MV 112. It will be apparent to a person having ordinary skill in the art that the abovementioned examples are for illustrative purposes and should not be construed to limit the scope of the disclosure.

The application server 106 may be further configured to select and allocate the vehicle with the highest rank to the ride request and communicate the allocation information to the passenger device 102 and a device (i.e., the vehicle device 110 or the driver device 116) of the allocated vehicle.

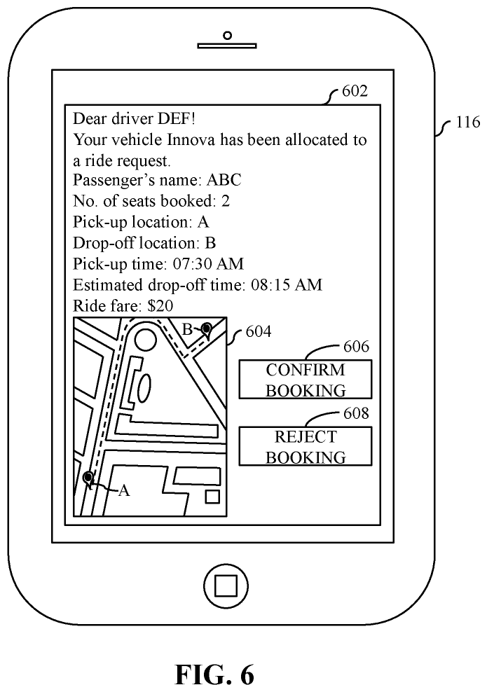

FIG. 6 is a block diagram that illustrates a notification interface 602 rendered on a display of the driver device 116 of FIG. 1, in accordance with an embodiment of the disclosure. The notification engine 212 may be configured to render the notification interface 602 on the display of the driver device 116, when the allocation engine 214 allocates the MV 112 to the ride request initiated by the passenger 104. The notification interface 602 may display a message that includes information about the ride. In an exemplary scenario, the information about the ride may include passenger name ‘ABC’, number of seats booked ‘2’, pick-up location ‘A’, drop-off location ‘B’, pick-up time ‘7:30 AM’, estimated drop-off time ‘08:15 AM’, ride fare $20, or the like. The notification interface 602 may further include a first navigation map 604 showing the pick-up location ‘A’, the drop-off location ‘B’, and an estimated route from the pick-up location ‘A’ to the drop-off location ‘B’.

The notification interface 602 may further include a plurality of options, such as a first ‘confirm booking’ option 606 and a second ‘reject booking’ option 608, selectable by the driver 114. The first ‘confirm booking’ option 606 may be selected by the driver 114 when the driver 114 wants to confirm the ride request. The first ‘reject booking’ option 608 may be selected by the driver 114 when the driver 114 wants to reject the ride request. The allocation engine 214 may be configured to allocate another vehicle to the ride request when the first ‘reject booking’ option 608 is selected by the driver 114.

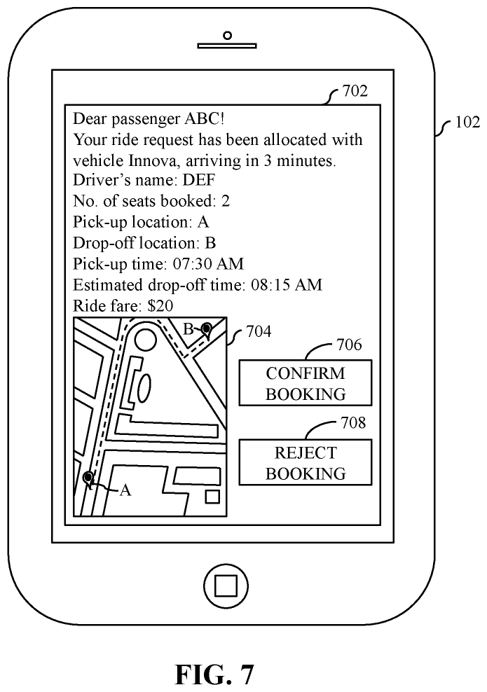

FIG. 7 is a block diagram that illustrates a notification interface 702 rendered on the display of the passenger device 102, in accordance with an exemplary embodiment of the disclosure. The notification engine 212 may be configured to render the notification interface 702 on the display of the passenger device 102 by way of the software application. The notification interface 702 may display a message to present the allocation information to the passenger 104 and prompt the passenger 104 to accept or reject the booking of the allocated vehicle (e.g., the AV 108 or the MV 112) for the ride. The displayed message may indicate an estimated arrival time of the allocated vehicle (e.g., 3 minutes), fare of the ride (e.g., $20), and/or details of the allocated vehicle (e.g., Innova). The displayed message may further indicate a name ‘DEF’ of the driver 114, number of seats booked ‘2’, the pick-up location ‘A’, the drop-off location ‘B’, the drop-off time ‘08:15 AM’, or the like. The notification interface 702 may further include a second navigation map 704 showing the pick-up location ‘A’, the drop-off location ‘B’, and the estimated route from the pick-up location ‘A’ to the drop-off location ‘B’. The booking of the allocated vehicle may be accepted by the passenger 104 by using a second ‘confirm booking’ option 706 included on the notification interface 702 and rejected by using a second ‘reject booking’ option 708 included on the notification interface 702. In another embodiment, if the AV 108 is allocated, the displayed message may not indicate the name of the driver 114.

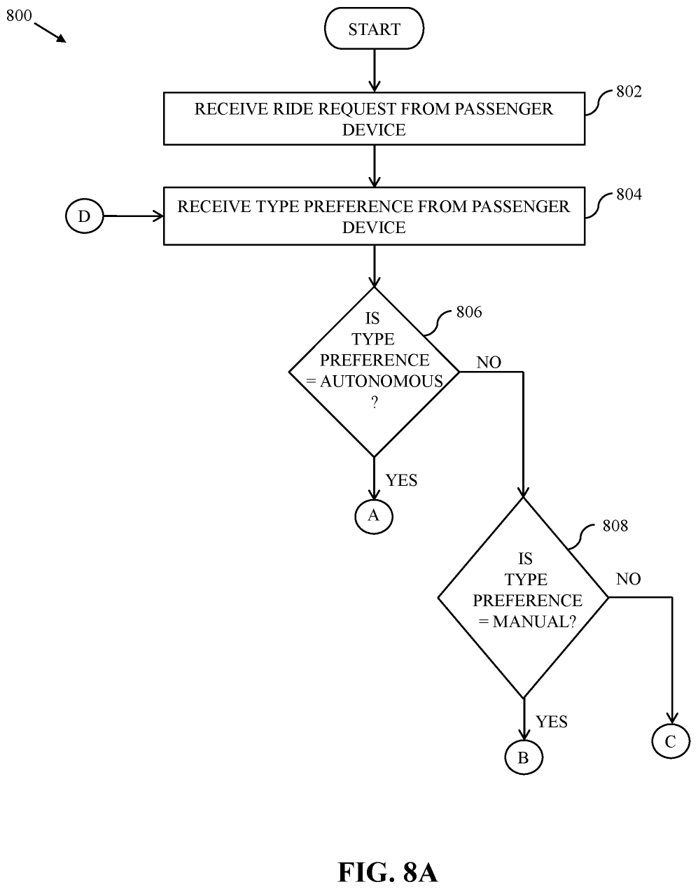

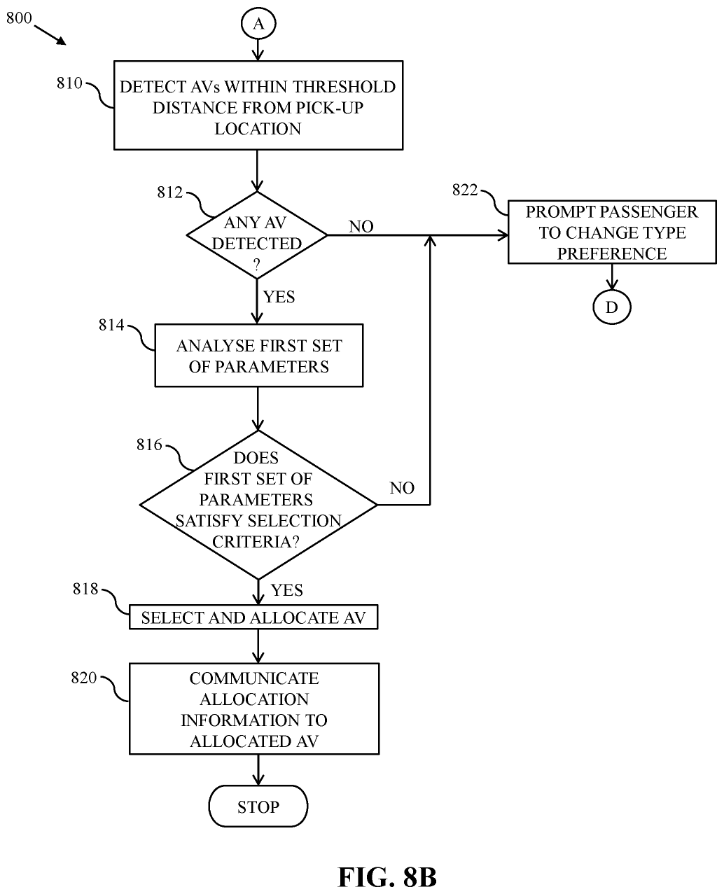

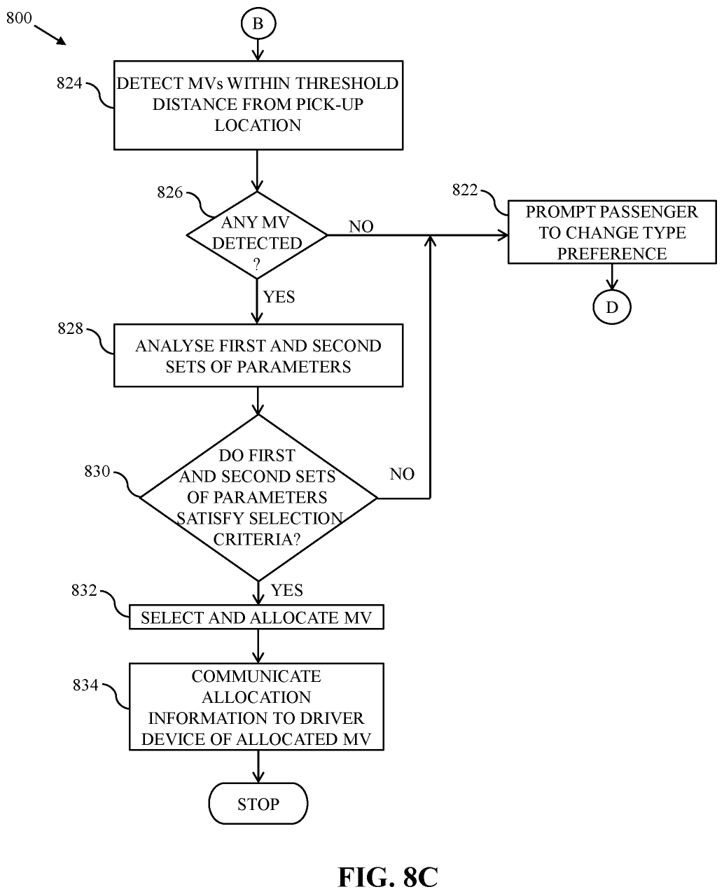

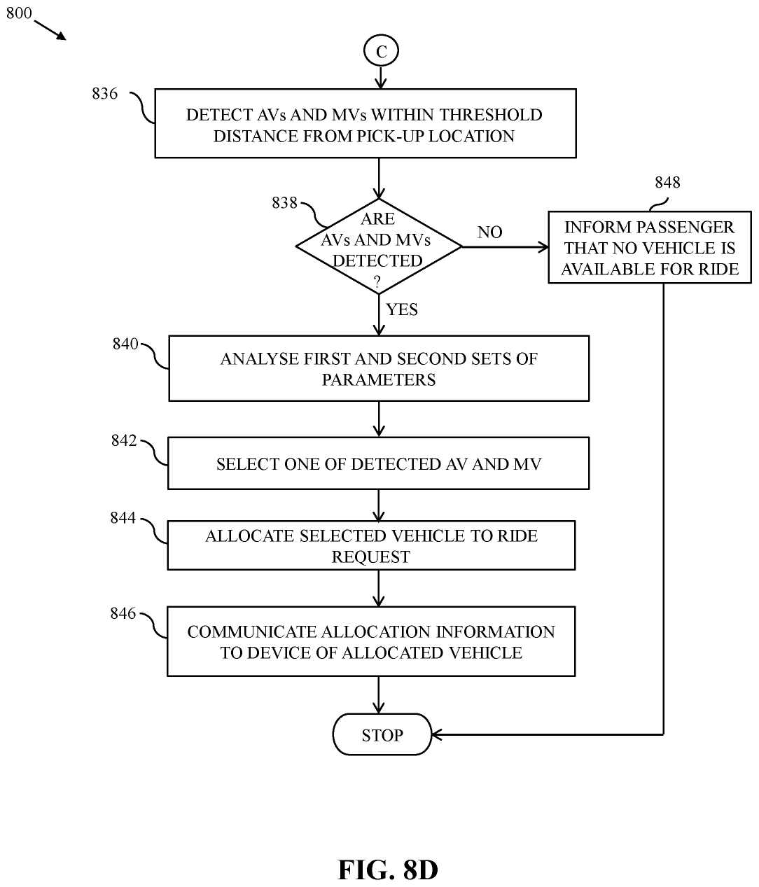

FIG. 8A-8D collectively, represent a flow chart 800 that illustrates a method for vehicle allocation, in accordance with an embodiment of the disclosure.

At 802, the ride request is received from the passenger device 102. The ride request received by the application server 106 may be initiated by using the booking interface 302 and may include the pick-up location of the passenger 104. At 804, the type preference is received from the passenger device 102. The type preference may be one of autonomous, manual, self-driven, or no preference. At 806, it is determined whether the type preference is autonomous. If at 806, it is determined that the type preference is not autonomous, then 808 is executed. If at 806, it is determined that the type preference is autonomous, then 810 is executed. At 810, AVs within the threshold distance from the pick-up location are detected. At 812, it is determined whether any AV is detected. If at 812, it is determined that at least one AV (e.g., the AV 108) is detected, then 814 is executed. At 814, the first set of parameters is analyzed. The application server 106 may be configured to determine the values of the first set of parameters associated with the detected AVs (e.g., the AV 108). At 816, it is determined whether the first set of parameters satisfies selection criteria (i.e., the availability parameter is ‘1’ and the safety score≥minimum threshold score). If at 816, it is determined that the first set of parameters associated with at least one of the detected AVs (e.g., the AV 108) satisfies the selection criteria, then 818 is executed. At 818, the AV 108 is selected and allocated. At 820, the allocation information is communicated to the allocated AV 108. The allocated AV 108 reaches the pick-up location to pick up the passenger 104 for the ride.

If at 816, it is determined that the first set of parameters associated with the detected AVs does not satisfy the selection criteria, then 822 is executed. At 822, the passenger 104 is prompted to change the type preference and then 804 is executed. If at 812, it is determined that no AV is detected, then 822 is executed.

At 808, it is determined whether the type preference is manual. If at 808, it is determined that the type preference is manual, then 824 is executed. At 824, MVs within the threshold distance from the pick-up location are detected. At 826, it is determined whether any MV is detected. If at 826, it is determined that at least one MV (e.g., the MV 112) is detected, then 828 is executed. At 828, the first and second sets of parameters are analyzed. The application server 106 may be configured to determine the values of the first set of parameters associated with the detected MVs (e.g., the MV 112) and the values of the second set of parameters associated with drivers of the detected MVs. At 830, it is determined whether the first and second sets of parameters satisfy the selection criteria (i.e., the availability parameter is ‘1’; the safety score≥minimum threshold score; the driving-duration parameter<the first threshold value; the earning parameter≤the second threshold value; and the driver-state parameter=‘1’). If at 830, it is determined that the first and second sets of parameters satisfy the selection criteria, then 832 is executed. At 832, the MV 112 is selected and allocated. At 834, the allocation information is communicated to the driver device 116 of the allocated MV 112.

If at 830, it is determined that the first and second sets of parameters associated with the MV 112 do not satisfy the selection criteria, then 822 is executed. At 822, the passenger 104 is prompted to change the type preference and 804 is executed. If at 826, it is determined that no MV is detected, then 822 is executed.

If at 808, it is determined that the type preference is not manual, then 836 is executed. In other words, no type preference may be provided by the passenger 104 indicating that the passenger 104 is comfortable with all vehicle types. At 836, AVs and MVs within the threshold distance from the pick-up location are detected. At 838, it is determined whether AVs and MVs are detected. If at 838, it is determined that at least one MV (e.g., the MV 112) and at least one AV (e.g., the AV 108) are detected, then 840 is executed. At 840, the first and second sets of parameters are analyzed. The application server 106 may be configured to determine the values of the first set of parameters associated with the detected MV 112 and the AV 108 and the values of the second set of parameters associated with the driver 114 of the detected MV 112. At 842, one of the detected AV 108 and the MV 112 is selected. The application server 106 is configured to select one of the detected AV 108 and the MV 112 for which the first and second sets of parameters satisfy the selection criteria (i.e., having the higher rank). At 844, the selected vehicle is allocated to the ride request. The application server 106 may allocate one of the AV 108 and the MV 112 that has the higher rank to the ride request. At 846, the allocation information is communicated to a device of the allocated vehicle. For example, when the MV 112 is allocated, the application server 106 may be configured to communicate the allocation information to the driver device 116. In another example, when the AV 108 is allocated, the application server 106 may be configured to communicate the allocation information to the vehicle device 110. Based on the allocation information, the allocated vehicle reaches the pick-up location to pick up the passenger 104. If at 838, it is determined that no vehicle is detected, then 848 is executed. At 848, the passenger 104 is informed that no vehicle is available for the ride.

In another embodiment, it may be determined that the type preference is self-driven (i.e., the passenger 104 wants to travel in a self-driven vehicle). The application server 106 may be configured to select and allocate the self-driven vehicle to the ride request of the passenger 104 by performing the method of FIGS. 8A-8D without deviating from the scope of the disclosure.

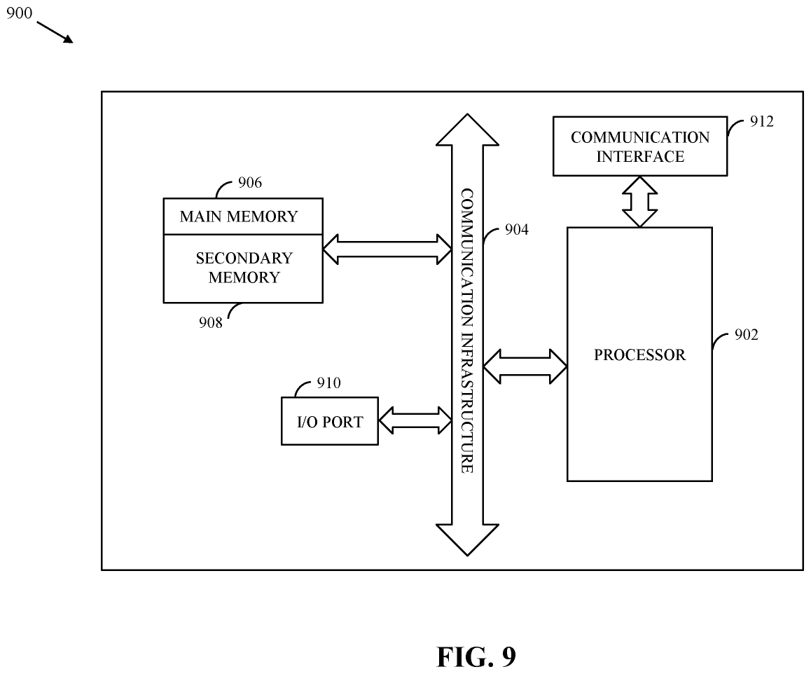

FIG. 9 is a block diagram that illustrates a computer system 900 for vehicle allocation, in accordance with an embodiment of the disclosure. An embodiment of the disclosure, or portions thereof, may be implemented as computer readable code on the computer system 900. In one example, the database server 118 and the application server 106 of FIG. 1 may be implemented in the computer system 900 using hardware, software, firmware, non-transitory computer readable media having instructions stored thereon, or a combination thereof and may be implemented in one or more computer systems or other processing systems. Hardware, software, or any combination thereof may embody modules and components used to implement the methods of FIGS. 8A, 8B, 8C, and 8D.

The computer system 900 includes a processor 902 that may be a special purpose or a general purpose processing device. The processor 902 may be a single processor, multiple processors, or combinations thereof. The processor 902 may have one or more processor “cores.” Further, the processor 902 may be connected to a communication infrastructure 904, such as a bus, a bridge, a message queue, the communication network 120, multi-core message-passing scheme, or the like. The computer system 900 further includes a main memory 906 and a secondary memory 908. Examples of the main memory 906 may include random access memory (RAM), read-only memory (ROM), and the like. The secondary memory 908 may include a hard disk drive or a removable storage drive (not shown), such as a floppy disk drive, a magnetic tape drive, a compact disc, an optical disk drive, a flash memory, or the like. Further, the removable storage drive may read from and/or write to a removable storage device in a manner known in the art. In an embodiment, the removable storage unit may be a non-transitory computer readable recording media.

The computer system 900 further includes an input/output (I/O) port 910 and a communication interface 912. The I/O port 910 includes various input and output devices that are configured to communicate with the processor 902. Examples of the input devices may include a keyboard, a mouse, a joystick, a touchscreen, a microphone, and the like. Examples of the output devices may include a display screen, a speaker, headphones, and the like. The communication interface 912 may be configured to allow data to be transferred between the computer system 900 and various devices that are communicatively coupled to the computer system 900. Examples of the communication interface 912 may include a modem, a network interface, i.e., an Ethernet card, a communications port, and the like. Data transferred via the communication interface 912 may be signals, such as electronic, electromagnetic, optical, or other signals as will be apparent to a person skilled in the art. The signals may travel via a communications channel, such as the communication network 120 which may be configured to transmit the signals to the various devices that are communicatively coupled to the computer system 900. Examples of the communication channel may include a wired, wireless, and/or optical medium such as cable, fiber optics, a phone line, a cellular phone link, a radio frequency link, and the like. The main memory 906 and the secondary memory 908 may refer to non-transitory computer readable mediums that may provide data that enables the computer system 900 to implement the booking methods illustrated in FIGS. 8A, 8B, 8C, and 8D.

A person having ordinary skill in the art will appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device. For instance, at least one processor, such as the processor 902, and a memory, such as the main memory 906 and the secondary memory 908, implement the above described embodiments. Further, the operations may be described as a sequential process, however some of the operations may in fact be performed in parallel, concurrently, and/or in a distributed environment, and with program code stored locally or remotely for access by single or multiprocessor machines. In addition, in some embodiments, the order of operations may be rearranged without departing from the spirit of the disclosed subject matter.

Various embodiments of the disclosure provide the application server 106 for vehicle allocation. The application server 106 may receive, from the passenger device 102 of the passenger 104, the ride request including the pick-up location (e.g., the first location ‘A’). The application server 106 may analyze, based on the ride request, the set of parameters associated with a plurality of vehicles, including at least one AV 108 and at least one MV 112, that are detected within the threshold distance of the pick-up location. The set of parameters includes the dry run parameter associated with the plurality of vehicles. The dry run parameter associated with a detected vehicle (e.g., the AV 108 and the MV 112) of the plurality of vehicles is indicative of one of a time duration taken and a distance travelled by the detected vehicle to reach the pick-up location from a current location of the detected vehicle. The application server 106 may select the AV 108 from the plurality of vehicles based on the analysis of the set of parameters. The AV 108 is selected by the application server 106 when a value of the dry run parameter associated with the AV 108 is less than a value of the dry run parameter associated with the MV 112. The application server 106 may allocate the selected AV 108 to the ride request.

Various embodiments of the disclosure provide the application server 106 for vehicle allocation. The application server 106 may receive, from the passenger device 102 of the passenger 104, the ride request including the pick-up location (e.g., the first location ‘A’). The application server 106 may analyze, based on the ride request, the set of parameters associated with a plurality of vehicles, including at least one AV 108 and at least one MV 112, that are detected within the threshold distance of the pick-up location. The set of parameters includes the dry run parameter associated with the plurality of vehicles. The dry run parameter associated with a detected vehicle (e.g., the AV 108 and the MV 112) of the plurality of vehicles is indicative of one of a time duration taken and a distance travelled by the detected vehicle to reach the pick-up location from a current location of the detected vehicle. The application server 106 may select the MV 112 from the plurality of vehicles based on the analysis of the set of parameters. The MV 112 is selected by the application server 106 when a value of the dry run parameter associated with the MV 112 is less than a value of the dry run parameter associated with the AV 108. The application server 106 may allocate the selected MV 112 to the ride request.

Various embodiments of the disclosure provide a non-transitory computer readable medium having stored thereon, computer executable instructions, which when executed by a computer, cause the computer to execute operations for vehicle allocation. The operations include receiving, by the application server 106 from the passenger device 102 of the passenger 104, the ride request including the pick-up location (e.g., the first location ‘A’). The operations further include analyzing, by the application server 106, based on the ride request, the set of parameters associated with a plurality of vehicles, including at least one AV 108 and at least one MV 112, that are detected within the threshold distance of the pick-up location. The set of parameters includes the dry run parameter associated with the plurality of vehicles. The dry run parameter associated with a detected vehicle (e.g., the AV 108 and the MV 112) of the plurality of vehicles is indicative of one of a time duration taken and a distance travelled by the detected vehicle to reach the pick-up location from a current location of the detected vehicle. The operations further include selecting, by the application server 106, the AV 108 from the plurality of vehicles based on the analysis of the set of parameters. The AV 108 is selected by the application server 106 when a value of the dry run parameter associated with the AV 108 is less than a value of the dry run parameter associated with the MV 112. The operations further include allocating, by the application server 106, the selected AV 108 to the ride request.

Various embodiments of the disclosure provide a non-transitory computer readable medium having stored thereon, computer executable instructions, which when executed by a computer, cause the computer to execute operations for vehicle allocation. The operations include receiving, by the application server 106 from the passenger device 102 of the passenger 104, the ride request including the pick-up location (e.g., the first location ‘A’). The operations further include analyzing, by the application server 106, based on the ride request, the set of parameters associated with a plurality of vehicles, including at least one AV 108 and at least one MV 112, that are detected within the threshold distance of the pick-up location. The set of parameters includes the dry run parameter associated with the plurality of vehicles. The dry run parameter associated with a detected vehicle (e.g., the AV 108 and the MV 112) of the plurality of vehicles is indicative of one of a time duration taken and a distance travelled by the detected vehicle to reach the pick-up location from a current location of the detected vehicle. The operations further include selecting, by the application server 106, the MV 112 from the plurality of vehicles based on the analysis of the set of parameters. The MV 112 is selected by the application server 106 when a value of the dry run parameter associated with the MV 112 is less than a value of the dry run parameter associated with the AV 108. The operations further include allocating, by the application server 106, the selected MV 112 to the ride request.

The disclosed embodiments encompass numerous advantages. Technological improvements in the application server 106 help the AVs to ply on roads in tandem with MVs. The AVs and MVs are allocated to ride requests by taking into consideration parameters associated with drivers (e.g., earning parameter, driving-duration parameter, driver's state, or the like), vehicles, and the passenger. Technological improvements in the application server 106 allow the application server 106 to perform the allocation of the AVs and MVs in such a manner that the drivers (e.g., the driver 114) of the MVs are neither overburdened nor underutilized, while increasing the overall profitability of the transport provider and improving the travelling experience of the passenger 104.

Conventional transport systems may allocate an MV whose driver has already earned a minimum daily wage while another driver who has not earned the minimum daily wage may be ignored. In addition to this, an AV may be preferred over an MV in spite of the fact that the driver of the MV has not earned the minimum daily wage. However, the application server 106 takes into consideration the earning parameter of each driver employed by the transport provider while allocating vehicles to the ride requests, thus, ensuring optimum work distribution among the drivers. The application server 106 further considers the safety score of the vehicles as an important parameter during vehicle allocation, thereby ensuring travel safety to the passenger 104. In other words, the technological improvements the application server 106 solve the challenges faced by the conventional transportation systems and improve the vehicle allocation.

Techniques consistent with the disclosure provide, among other features, systems and methods for vehicle allocation. Unless stated otherwise, terms such as “first” and “second” are used to arbitrarily distinguish between the elements such terms describe. Thus, these terms are not necessarily intended to indicate temporal or other prioritization of such elements. While various exemplary embodiments of the disclosed system and method have been described above it should be understood that they have been presented for purposes of example only, not limitations. It is not exhaustive and does not limit the disclosure to the precise form disclosed. Modifications and variations are possible in light of the above teachings or may be acquired from practicing of the disclosure, without departing from the breadth or scope.

What is claimed is:

1. A method, comprising:
receiving, by a server, from a passenger device of a passenger, a ride request including at least a pick-up location;
analyzing, by the server, based on the ride request, a set of parameters associated with a plurality of vehicles, including at least one autonomous vehicle (AV) and at least one manually-driven vehicle (MV), that are detected within a threshold distance of the pick-up location, wherein the set of parameters includes at least a dry run parameter associated with the plurality of vehicles, and wherein the dry run parameter associated with a detected vehicle of the plurality of vehicles is indicative of one of a time duration taken, or a distance travelled, by the detected vehicle to reach the pick-up location from a current location of the detected vehicle;
selecting, by the server, the AV from the plurality of vehicles based on the analysis of the set of parameters, wherein the AV is selected when a value of the dry run parameter associated with the AV is less than a value of the dry run parameter associated with the MV; and
allocating, by the server, the selected AV to the ride request.

2. The method of claim 1, further comprising:
determining, by the server, a current supply of the plurality of vehicles, real-time climate and road conditions, and working hours of a driver of the MV, for analyzing the set of parameters; and
communicating, by the server, allocation information to the allocated AV, such that the allocated AV uses the allocation information for reaching the pick-up location from a current location.

3. The method of claim 1, wherein the set of parameters further includes an availability parameter, a dead run parameter, or a safety score associated with the plurality of vehicles.

4. The method of claim 3, wherein the AV is selected when the availability parameter associated with the AV indicates that the AV is available and the availability parameter associated with the MV indicates that the MV is unavailable, and wherein the availability parameter associated with the detected vehicle indicates whether the detected vehicle is available for allocation.

5. The method of claim 3, wherein the AV is selected when a value of the dead run parameter associated with the AV is greater than a value of the dead run parameter associated with the MV, and wherein the dead run parameter associated with the detected vehicle is indicative of one of a time duration for which the detected vehicle is without allocation or a distance travelled by the detected vehicle without allocation.

6. The method of claim 3, wherein the AV is selected when a value of the safety score associated with the AV is greater than a value of the safety score associated with the MV, and wherein the safety score associated with the detected vehicle indicates a degree of safeness for the detected vehicle to reach a drop-off location from the pick-up location.

7. The method of claim 1, wherein the set of parameters further includes a driving-duration parameter, an earning parameter, or a driver-state parameter associated with a driver of the MV, and a preference parameter that indicates a vehicle preference of the passenger.

8. The method of claim 7, wherein the AV is selected when the driving-duration parameter associated with the driver is greater than a first threshold.

9. The method of claim 7, wherein the AV is selected when the earning parameter associated with the driver is greater than or equal to a second threshold.

10. The method of claim 7, wherein the AV is selected when the driver state parameter indicates that a current driving pattern of the driver is deviating from a standard driving pattern.

11. The method of claim 7, wherein the AV is selected when the preference parameter indicates that the passenger prefers the AV for the ride request.

12. A method, comprising:
receiving, by a server from a passenger device of a passenger, a ride request including at least a pick-up location and a drop-off location;
analyzing, by the server, based on the ride request, a set of parameters associated with a plurality of vehicles, including at least one autonomous vehicle (AV) and at least one manually-driven vehicle (MV), that are detected within a threshold distance of the pick-up location, wherein the set of parameters includes at least a dry run parameter associated with the plurality of vehicles, and wherein the dry run parameter associated with a detected vehicle of the plurality of vehicles is indicative of one of a time duration taken, or a distance travelled, by the detected vehicle to reach the pick-up location from a current location of the detected vehicle;
selecting, by the server, the MV from the plurality of vehicles based on the analysis of the set of parameters, wherein the MV is selected when a value of the dry run parameter associated with the MV is less than a value of the dry run parameter associated with the AV; and
allocating, by the server, the selected MV to the ride request.

13. The method of claim 12, further comprising:
determining, by the server, a current supply of the plurality of vehicles, real-time climate and road conditions, and working hours of a driver of the MV, for analyzing the set of parameters; and
communicating, by the server, allocation information to the allocated MV, such that the driver of the MV uses the allocation information for reaching the pick-up location from a current location.

14. The method of claim 12, wherein the set of parameters further includes an availability parameter, a dead run parameter, or a safety score associated with the plurality of vehicles.

15. The method of claim 14, wherein the MV is selected when a value of the dead run parameter associated with the MV is greater than a value of the dead run parameter associated with the AV, and wherein the dead run parameter associated with the detected vehicle is indicative of one of a time duration for which the detected vehicle is without allocation or a distance travelled by the detected vehicle without allocation.

16. The method of claim 14, wherein the MV is selected when a value of the safety score associated with the MV is greater than a value of the safety score associated with the AV, and wherein the safety score associated with the detected vehicle indicates a degree of safeness for the detected vehicle to reach a drop-off location from the pick-up location.

17. The method of claim 12, wherein the set of parameters further includes a driving-duration parameter, an earning parameter, or a driver-state parameter associated with a driver of the MV, and a preference parameter that indicates a vehicle preference of the passenger.

18. The method of claim 17, wherein the MV is selected when the driving-duration parameter associated with the driver is less than or equal to a first threshold.

19. The method of claim 17, wherein the MV is selected when the earning parameter associated with the driver is less than a second threshold.

20. The method of claim 17, wherein the MV is selected when the driver state parameter indicates that a current driving pattern of the driver is matching a standard driving pattern.
